(19) United States
(12) Patent Application Publication
(10) Pub. No.: US 2010/0327167 A1
(43) Pub. Date: Dec. 30, 2010

(54) Spectroscopic gas sensor and method for ascertaining an alcohol concentration in a supplied air volume, in particular an exhaled volume

(76) Inventors: Paul Koop, Stuttgart (DE); Helge Dittmer, Tuebingen (DE)

Correspondence Address: KENYON & KENYON LLP, ONE BROADWAY, NEW YORK, NY, 10004, US

(21) Appl. No.: 12/802,703

(22) Filed: Jun. 11, 2010

(30) Foreign Application Priority Data
Jun. 24, 2009 (DE) 10 2009 027 139.2

(51) Int. Cl. G01J 5/02

(52) U.S. Cl. 250/339.13

(57) ABSTRACT

A spectroscopic gas sensor is disclosed, which has at least: an IR radiation source for emitting IR radiation, a measuring volume to be completely or partially filled with an air supply volume, in particular an exhaled air, a detector unit having at least one, preferably two detector elements for detecting the IR radiation passing through the measuring volume in at least one first wavelength range and outputting measuring signals, and an analyzer unit for recording the measuring signals and ascertaining a concentration of a measured substance in the air supply volume. A first detector element measures IR radiation in a wavelength range of an absorption band of the measured substance, and the analyzer unit ascertains a concentration of the measured substance in the air supply volume from the ascertained concentrations of the measured substance and a further component in the measuring volume. For this purpose, a second detector means measures the concentration of the further component of the air supply volume, preferably as a second spectroscopic detector element.

### BACKGROUND OF THE INVENTION

1. Field of the Invention

The present invention relates to spectroscopic gas sensors based on the absorption of infrared radiation (IR radiation) in a measuring volume according to the gas composition.

2. Description of Related Art

For this purpose, in general IR radiation is conducted from an IR radiation source through the measuring volume and the absorption of the IR radiation in various wavelength ranges is detected by detector elements, in order to analyze the gas mixture. In general, wavelength ranges containing absorption bands of the gas components to be determined are used for this purpose. In general, a reference channel having a further detector element is additionally used, which measures in a broadband wavelength range, for example.

Inter alia, the alcohol concentration in the measuring volume of a measuring device, into which a person exhales, may be determined by a spectroscopic gas sensor of this type. In order to be able to conclude the alcohol concentration in the exhaled air of the person therefrom, however, it is to be ensured that the measuring volume between the detector and the IR radiation source has been completely filled with the exhaled air. For example, an inflatable bag having a suitable mouthpiece may be used for this purpose, previous remaining residual air in the bag and the mouthpiece possibly resulting in inaccuracies even in this case. For reasons of hygiene, measuring units of this type having a mouthpiece may generally only be used once.

### SUMMARY OF THE INVENTION

The present invention is based on the idea of ascertaining the concentration of a measured substance, in particular alcohol, in a measuring volume even without precise knowledge of the proportion of the supplied air or the exhaled air in the measuring volume. A mouthpiece may thus fundamentally be dispensed with; instead of an inflatable bag, for example, a solid container body, which is not completely filled by the supplied air, i.e., the exhaled air, may thus also be used as the container for the measuring volume.

According to the present invention, the alcohol concentration in the exhaled air is indirectly ascertained via a supplementary measurement of a further component or substance. According to the present invention, not only the concentration of the alcohol, but rather also the concentrations of further components are thus measured in the measuring volume.

This measurement of the further components may also be performed spectroscopically in particular, so that the detector unit according to the present invention has at least two detector elements, of which a first detector element detects IR radiation in a wavelength range of an absorption band of the measured substance and a second detector element detects IR radiation in a wavelength range of an absorption band of the further component. A further measurement is advantageously additionally performed in a reference channel, in order (in a way known per se) to calibrate or convert the measured values, which initially represent relative values, using this reference channel.

Instead of a spectroscopic measurement of the second component, however, another, measurement may also be performed, e.g., via a chemical sensor situated in the reflector volume.

According to the present invention, initially a first measurement may be performed in the measuring volume before receiving the exhaled air and subsequently the measurement may be performed in the measuring volume having received exhaled air as the second measurement; depending on the specific embodiment, the first measurement may not be necessary.

The content of this component in the exhaled air is additionally ascertained. A suitable component is advantageously selected, whose concentration in the exhaled air may be estimated with sufficient precision, so that the alcohol concentration in the exhaled air may be ascertained indirectly through this estimated value of the component in the exhaled air and through the measured values of this component and of the alcohol content in the measuring volume, optionally taking into account additional compensations.

A compensation may be performed in particular via an ascertained temperature in the exhaled air and/or in the measuring volume. For this purpose, for example, temperature sensors or temperature probes having high measuring precision and rapid response time may be used, for example, a resistor element having positive or negative characteristic curve.

It is recognized according to the present invention that water, oxygen, and carbon dioxide are suitable in particular as the further component, because the content of these components in the exhaled air may be estimated with high precision. The water content in the exhaled air of a human is essentially a function of the temperature of his exhaled air. Furthermore, the oxygen content or the oxygen concentration and the carbon dioxide content in the exhaled air of a human are also known with sufficient precision.

The present invention has multiple advantages. Thus, the high measuring precision of spectroscopic gas sensors may be used for measuring the alcohol concentration, which, on the one hand, is more precise and, on the other hand, allows multiple usability and thus repeatability of the measurement in relation to other measuring methods, such as chemical measuring methods by coloring of an indicator, or chemical sensors. Furthermore, according to the present invention, a mouthpiece at the inlet into the measuring volume may be dispensed with, so that a hygienically advantageous approach and in particular also a reusability of the spectroscopic gas sensor are made possible. The user may thus also exhale into an inlet without contact with the housing of the gas sensor, so that he will generally only fill a part of the measuring volume with the exhaled air, a high measuring precision nonetheless being achieved according to the present invention by the indirect ascertainment. Independence of the measurement from the quantity or the proportion of the exhaled air in the measuring volume is thus achieved according to the present invention.

The gas sensor according to the present invention may be implemented for wavelength-selective measurement via components known per se, which are also standardized for other measurements, such as detector semiconductor components having micromechanical detector elements and optical filters, which are cost-effective and usable multiple times. The measuring volume may be formed by a rigid housing; longer absorption paths and thus a high measuring precision also may be achieved here in a measuring volume, which is small per se, by reflectors, for example. For this purpose, for example, the entire measuring volume may be received between appropriate reflector units, which allow long absorption paths by multiple reflections.

### BRIEF DESCRIPTION OF THE SEVERAL VIEWS OF THE DRAWING

FIG. 1 shows the schematic construction of a gas sensor according to the present invention.

FIG. 2 shows a flow chart of an analysis method according to the present invention.

### DETAILED DESCRIPTION OF THE INVENTION

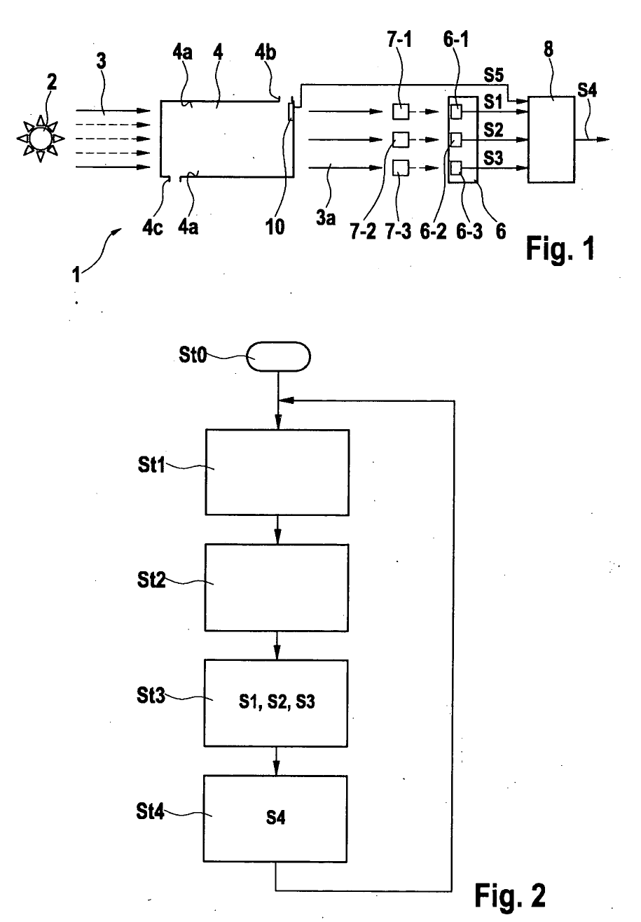

A spectroscopic gas sensor 1 according to the present invention has an IR radiation source 2, which emits IR radiation 3 in a broadband range, according to FIG. 1. For this purpose, IR radiation source 2 may be implemented as an incandescent lamp in low-power operation, for example, which accordingly emits broadband thermal IR radiation 3. IR radiation 3 subsequently passes through a measuring volume 4, which is used as the absorption route. Measuring volume 4 may be established in particular by reflectors 4a (not shown in greater detail here), in order to lengthen the absorption paths in restricted installation space. Furthermore, an inlet 4b and an outlet 4c for the intake and outlet of a gas volume 9 to be supplied into measuring volume 4 are schematically shown. Gas volume 9 to be supplied may be in particular an exhaled air 9 of a person. Inlet 4b may be implemented without a mouthpiece according to the present invention.

A partial absorption of broadband IR radiation 3 occurs in measuring volume 4 as a function of the composition of the received gas or gas mixture, so that subsequently IR radiation 3a leaves measuring volume 4 and reaches multiple optical filters 7-1, 7-2, 7-3, which are each situated upstream from a detector element 6-1, 6-2, 6-3 of a detector 6 and each transmit different wavelength ranges of incoming IR radiation 3a.

Detector elements 6-1, 6-2, 6-3 may be implemented micromechanically in common detector 6, for example, which is implemented as one or also multiple detector semiconductor components 6. Detector elements 6-1, 6-2, 6-3 thus detect IR radiation 3a in different wavelength ranges established by optical filters 7-1, 7-2, 7-3. For this purpose, for example, third detector element 6-3 may be used as a reference channel and measure the incoming broadband IR radiation, and first detector element 6-1 may measure in an absorption band of alcohol at 9.3 μm, for example. Second detector element 6-2 is used according to the present invention as a further measuring channel for the detection of a further component S, which may be in particular H₂O (water), O₂ (oxygen), or CO₂ (carbon dioxide). The implementation of multiple additional detector elements 6-2 of this type is also possible for this purpose according to the present invention, in order to increase the precision of the measurement; thus, for example, two second detector elements 6-2 may be provided, one of which detects O₂ and the other H₂O. In an implementation of this type, four detector elements 6-1, 6-2, 6-2, and 6-3 may be implemented as two channels each in two detector semiconductor components, for example.

Detector elements 6-1, 6-2, 6-3 each output measuring signals S1, S2, S3 to an analyzer unit 8, which may be implemented as a further semiconductor component, e.g., an ASIC, or also may be implemented in the microprocessor, for example, which activates IR radiation source 2. Analyzer unit 8 outputs an output signal S4.

To ascertain the alcohol content in exhaled air 9 as a function of further components S used for the ascertainment, a first measurement may initially be performed before the supply of the exhaled air 9, in which IR radiation source 2 emits IR radiation 3 through measuring volume 4 and the measuring signals are recorded. The first measurement is helpful in particular if H₂O is used as the further component; for O₂ or CO₂, this first measurement may fundamentally be dispensed with, because the starting value may be estimated.

Exhaled air 9 is subsequently received in measuring volume 4 via inlet 4b, whereby entire measuring volume 4 is generally not filled with exhaled air 9, in particular if no mouthpiece is provided at inlet 4b, but rather the user exhales into a corresponding opening used as inlet 4b. For the measurement, inlet 4b and outlet 4c are subsequently closed, so that IR radiation source 2 emits IR radiation 3 through measuring volume 4.

The present invention is based on the consideration that the proportion of exhaled air 9 in measuring volume 4 may be estimated indirectly if the concentration of further component S in the measuring volume is measured and estimated in the exhaled air.

If, for a component S, which may be H₂O or O₂ or CO₂, for example,
C(S)v is the concentration of component S in measuring volume 4 before the partial filling with exhaled air 9,
C(S)n is the concentration of component S in measuring volume 4 after the partial filling with exhaled air 9,
C(S)9 is the concentration of component S in exhaled air 9,
C(Al)v is the alcohol content in measuring volume 4 before the partial filling with exhaled air 9,
C(Al)n is the alcohol content in measuring volume 4 after the partial filling with exhaled air 9,
   and
C(Al)9 is the alcohol content in exhaled air 9, i.e., the value to be determined.

The following quotient x of the relevant differences results in the proportional or relative value of the air remaining in measuring volume 4:

x=(C(S)n−C(S)9)/(C(S)v−C(S)9),

therefore, y=1−x specifies the relative value of the displaced volume in measuring volume 4.

If the alcohol measured values before and after the filling or exhalation are now set into relation and divided by (1−x), alcohol content C(Al)9 to be determined in exhaled air 9 is obtained:

C(Al)9=(C(Al)n−x*C(Al)v)/(1−x)

If S=H₂O, the relative humidities, i.e., values up to 100%, may also be taken, the temperature also being compensated for if needed.

According to the present invention, C(Al)v, C(Al)n, C(S)v, and C(S)n may be detected in the measurements, all values being detected spectroscopically, or C(S)v and C(S)n may also be detected chemically. In particular, C(Al)v, i.e., the alcohol content in measuring volume 4 before the partial filling with exhaled air 9, may be set to practically zero by prior cleaning or flushing with the outside air. Furthermore, for some components S, concentration value C(S)9, i.e., the concentration of component S in exhaled air 9, may advantageously be estimated or known.

It is recognized according to the present invention that water in the exhaled air of a person has a concentration which is essentially only a function of temperature T. For S=H₂O, C(H₂O)9, i.e., the water concentration in exhaled air 9, may thus be estimated via knowledge of temperature T, which is measured via temperature probe 10, which outputs a temperature signal S5. C_{T} is thus introduced as a temperature correction factor.

An example is calculated below, the humidities (having values up to 100%) being taken directly and the temperature being compensated via a temperature factor C_{T}:

Let the concentration of H₂ in the measuring volume be 50% (humidity) before the measurement. After the partial filling by exhaled air 9, the concentration will rise to 75%. The following proportion x was thus displaced by exhaled air 9:

x=(75%−100%)/(50%−100%)=0.5, i.e., 50%.

If the alcohol concentration is 100 ppm before filling, 150 ppm is measured after the partial filling with exhaled air 9. In order to calculate alcohol concentration C(Al)9 in exhaled air 9, the above formula must be rearranged:

C(Al)9=(150 ppm−0.5*100 ppm)/(1−0.5)=200 ppm

As already noted, upon prior cleaning of measuring volume 4, it is also fundamentally possible that there is no alcohol in measuring volume 4 before the filling, so that the calculation is then simplified.

For S=CO₂, value C(CO₂)v of the CO₂ content in measuring volume 4 of the first measurement, i.e., before the partial filling, may be set vanishingly small (less than one part per thousand) in relation to C(CO₂)9, i.e., the CO₂ value in exhaled air 9, which is known for a person and is approximately 4%. Thus:

x=(C(CO₂)n−C(CO₂)9)/(C(CO₂)v−C(CO₂)9)≈1−(C(CO₂)n/0.04)

The concentration values of C(Al)v and C(Al)n and C(CO₂)n may again be ascertained, for example, via detector unit 6 having detector elements 6-1, 6-2, 6-3, for example, 6-1 detecting an absorption band of alcohol and 6-2 an absorption band of CO₂ and 6-3 being used as a reference channel.

According to a third specific embodiment, S=O₂, i.e., oxygen, is used as the second substance.

The concentration values of alcohol and oxygen in measuring volume 4 are again advantageously ascertained via detector unit 6 having detector elements 6-1, 6-2, 6-3, for example 6-1 detecting an absorption band of alcohol and 6-2 an absorption band of oxygen and 6-3 being used as a reference channel.

In this specific embodiment, C(O₂)9, i.e., the concentration of oxygen in exhaled air 9, is again estimated. The oxygen content in the atmospheric air may be estimated with sufficient precision as 21%; an oxygen concentration of 17% is generally present in the exhaled air of a person, which is known with sufficient precision.

Therefore, alcohol concentration C(Al)9 in exhaled air 9 may thus also be ascertained according to this formula.

These three specific embodiments may also be combined with one another in particular, so that oxygen, carbon dioxide, and water may be used as the additional substance for the indirect ascertainment of the alcohol concentration in the exhaled air.

The measuring method according to the present invention thus starts according to FIG. 2 in step St0 upon startup by the user. Subsequently, in step St1, exhaled air 9 is received in measuring volume 4, the air generally not completely filling up measuring volume 4, in particular if no additional mouthpiece is provided at inlet 4b. Inlet 4b and accordingly outlet 4c are subsequently closed in step St2. In step St2, IR radiation 3 is emitted by IR radiation source 2 and conducted through measuring volume 4, upon which detector elements 6-1, 6-2, 6-3 and optionally further detector elements subsequently output their measuring signals S1, S2, S3 in step St3. Furthermore, temperature signal S5 is generated by temperature sensor 10 and output to analyzer unit 8.

C(Al)9 is subsequently ascertained as the alcohol concentration in exhaled air 9 in step St4 according to one of the specific embodiments or a combined specific embodiment, or also via reference calculation or ascertainment using a further substance present in the exhaled air and output signal S4 is output, which may display the value of C(Al)9 directly, for example, also on a display unit of the measuring device according to the present invention.

What is claimed is:

1. A spectroscopic gas sensor, comprising:
an IR radiation source for emitting IR radiation, a measuring volume to be completely or partially filled with an air supply volume, in particular an exhaled air,
a detector unit having at least one detector element for detecting the IR radiation passing through the measuring volume in at least one first wavelength range and outputting at least one measuring signal, and
an analyzer unit for recording the at least one measuring signal and ascertaining a concentration of a measured substance in the air supply volume,
wherein a first detector element measures IR radiation in a wavelength range of an absorption band of the measured substance and outputs a first measuring signal to the analyzer unit,
a second detector element measures a concentration of a further component of the air supply volume and outputs a second measuring signal, and
the analyzer unit ascertains a concentration of the measured substance in the air supply volume from the ascertained concentrations of the measured substance and the further component in the measuring volume.

2. The spectroscopic gas sensor as recited in claim 1, wherein the analyzer unit estimates a concentration of the further component in the air supply volume and ascertains the concentration of the measured substance in the air supply volume from the estimated concentration of the further component in the air supply volume and the measured concentrations of the measured substance and of the further component in the measuring volume.

3. The spectroscopic gas sensor as recited in claim 1, wherein the second detector element is a second detector element of the detector unit, the second detector element detecting the IR radiation passing through the measuring volume in a second wavelength range, which is different from the first wavelength range, and which is associated with an absorption band of the further component of the air supply volume.

4. The spectroscopic gas sensor as recited in claim 2, wherein the second detector element is a second detector element of the detector unit, the second detector element detecting the IR radiation passing through the measuring volume in a second wavelength range, which is different from the first wavelength range, and which is associated with an absorption band of the further component of the air supply volume.

5. The spectroscopic gas sensor as recited in claim 1, wherein the measured substance is ethanol.

6. The spectroscopic gas sensor as recited in claim 2, wherein the measured substance is ethanol.

7. The spectroscopic gas sensor as recited in claim 3, wherein the measured substance is ethanol.

8. The spectroscopic gas sensor as recited in claim 1, further comprising a temperature probe for measuring a temperature of the exhaled air or the temperature in the measuring volume, which outputs a measuring signal to the analyzer unit to ascertain the concentration of the measured substance in the air supply volume.

9. The spectroscopic gas sensor as recited in claim 1, wherein water is used as a further component of the air supply volume, the water concentration in the exhaled air being estimated via a temperature measurement.

10. The spectroscopic gas sensor as recited in claim 1, wherein oxygen or carbon dioxide is measured as a further component of the air supply volume and the concentration of oxygen or carbon dioxide in the exhaled air is estimated.

11. The spectroscopic gas sensor as recited in claim 1, further comprising an optical filter for the wavelength-selective transmission of the incident IR radiation provided upstream from the at least one detector element in each case.

12. The spectroscopic gas sensor as recited in claim 1, wherein the at least one detector element is implemented micro-mechanically in a detector semiconductor component or in multiple detector semiconductor components.

13. The spectroscopic gas sensor as recited in claim 11, wherein the at least one detector element and the optical filters are implemented micro-mechanically in a detector semiconductor component or in multiple detector semiconductor components.

14. The spectroscopic gas sensor as recited claim 1, wherein the measuring volume has an inlet, which is implemented without a mouthpiece.

15. A method for the spectroscopic measurement of a concentration of a measured substance in a supplied air supply volume, comprising:
receiving the air supply volume in a measuring volume, emitting IR radiation from an IR radiation source through the measuring volume and wavelength-selective measuring the IR radiation passing through the measuring volume in at least one wavelength range,
ascertaining in one wavelength range, the concentration of the measured substance in the measuring volume in at least one measurement and ascertaining the concentration of a further component in the measuring volume,
ascertaining the concentration of the measured substance in the air supply volume via at least the measured value of the concentration in the measuring volume and the concentration of the further component in the measuring volume and ascertaining a concentration of the further component in the air supply volume.

16. The method as recited in claim 15, wherein the concentration of the further component in the air supply volume is estimated.

17. The method as recited in claim 16, wherein the concentration of the further component in the measuring volume is ascertained in a wavelength-selective manner in a further wavelength range before or after the air supply volume is received in the measuring volume.

18. The method as recited in claim 15, wherein the measured substance is ethanol and the further component is at least one of water, oxygen, and carbon dioxide, and the concentration of the further component in the exhaled air is ascertained or estimated with measurement of the temperature in exhaled air or in the measuring volume.
